(19) United States
(12) Patent Application Publication
(10) Pub. No.: US 2008/0077343 A1
(43) Pub. Date: Mar. 27, 2008

(54) IMPLEMENTATION OF CODED OPTICAL TIME-DOMAIN REFLECTOMETRY

(76) Inventor: Leif Albin Johansson, Goleta, CA (US)

Correspondence Address: Leif Johansson;Freedom Photonics LLC, #201, 75 Willow Springs Lane, Goleta, CA, 93117, US

(21) Appl. No.: 11/852,874

(22) Filed: Sep. 10, 2007

Related U.S. Application Data
(60) Provisional application No. 60/843,086, filed on Sep. 8, 2006.

(51) Int. Cl. G06F 19/00

(52) U.S. Cl. 702/71

(57) ABSTRACT

An implementation of coded time-domain reflectometry that can be incorporated in a transmitter as a built-in test function is disclosed. A sequence of a signal that is being transmitted is captured, delayed and used for correlation to a received reflected signal from the transmission medium. A correlation signal is obtained if the delay value of the captured signal sequence corresponds to the roundtrip delay from the transmitter to a reflection point of the medium. Based to the relation between delay values and the strength of the correlated signal, the magnitude of reflective points throughout the transmission medium can be evaluated. In the preferred embodiment, the transmitter is an optical transmitter, and the transmission medium is optical fiber.

### STATEMENT REGARDING FEDERALLY SPONSORED RESEARCH OR DEVELOPMENT:

This invention was made with Government support under Grant No. N68335-05-C-0293 (Field Portable, Low-cost Rugged Fiber Optic Reflectometer) awarded by NAVAIR. The Government has certain rights in this invention.

### REFERENCES CITED

U.S. Patent Documents:

| | | |
|---|---|---|
| 5,673,108 | September 1997 | Takeuchi |
| 6,885,954 | April 2005 | Jones, et al. |
| 7,011,453 | March 2006 | Harres |
| 7,027,685 | April 2006 | Harres |
| 7,245,800 | July 2007 | Uhlhorn |

### BACKGROUND OF THE INVENTION

Optical fiber reflectometry is a method for diagnosing reflections, breaks and losses in fiber optic cables, whether from fiber connections, terminations or imperfections in the fiber. There exist numerous methods to implement this. Currently, the overall most successful method is optical time-domain reflectometry (OTDR) in which an optical pulse is transmitted and the time dependent reflection is captured. This approach is limited in performance by a trade-off in sensitivity and resolution given by the width of the transmitted optical pulse. A narrow pulse will result in a high resolution but the small average transmitted power and the correspondingly small reflected power decreases sensitivity. A second limitation is the appearance of ‘dead-zones’ after a strong reflection. Due to the high required sensitivity of the optical receiver in the instrument, a strong reflection will temporarily saturate the receiver such that it is insensitive to any closely following weaker reflections. The time and correlating distance the receiver requires for recovery is called a ‘dead-zone’. This problem is particularly limiting close to connectors that typically has a strong reflection and are susceptible to damage or fiber bending losses close by. A variation of this OTDR approach is to transmit a coded burst of pulses instead of a single pulse. The trade-off between resolution and sensitivity is now eased, as the average optical power can now be increased without losing resolution, as given by the width of a single pulse. Commonly, this type of reflectometry, whether used in a fiber-optic transmission system or other transmission medium, uses special codes such as complementary Golay codes, which have a clean correlation spectrum, leading to improved sensitivity.

The second relevant method is optical frequency-domain reflectometry (OFDR). This approach typically is not as limited in tradeoffs in sensitivity and resolution and is not limited by dead-zones, as it transmits a continuous optical signal. Instead, the wavelength of the signal is changed in time at a constant rate, and the reflected signal is evaluated by observing the optical frequency difference between the transmitted and reflected signal. A large difference corresponds to a far away reflection. This method is limited by the requirement to maintain optical coherence and polarization matching between the transmitted and reflected signal. It usually requires a low-wavelength optical source and a complex optical arrangement to control coherence and polarization aspects to a degree that it is not a limiting factor. These difficulties have made this approach less commercially successful, as it leads to a bulky and sensitive apparatus.

Optical fiber reflectometry functionality can be incorporated in a fiber-optic transmitter, allowing a built-in test functionality to monitor the health of the fiber. Due to the complexity in nature, OFDR reflectometry approaches are not well-suited for this purpose, as it usually requires different optical component technology than is typically used in the transmitter. OTDR reflectometry built-in test has been proposed for optical transmitters. The typical problem is that either, the transmitter must cease the function of transmitting information to generate the optical pulses, or special codes needed to evaluate the fiber reflections, rendering the transmitter temporarily out of operation, or a second optical source, separated in wavelength must be added to the transmitter that has to be filtered at the remote destination of transmitted information.

### SUMMARY OF THE INVENTION

The present invention discloses a built-in test reflectometry architecture that neither requires interruption of normal operation of the optical transmitter, nor requires the addition of a second optical source in the transmitter.

In more detail, during normal operation of an optical transmitter, in which an information carrying signal is converted from the electrical domain to the optical domain, a sequence of the electrical signal fed to the transmitter is captured. Reflections from the optical fiber are then detected and the detected electrical signal is compared to the first captured signal sequence with delay added. A strong correlation between the detected and the first captured signal occurs when the added delay is equal to the roundtrip optical path delay to a reflective point in the optical fiber under test. In this manner, the location of an optical reflection point may be detected while during normal uninterrupted transmitter operation.

### BRIEF DESCRIPTION OF THE DRAWINGS

Referring to the drawings in which like reference numbers represent corresponding parts throughout:

FIG. 1: Schematic of basic embodiment of code-correlation OTDR.

FIG. 2: Schematic of extended embodiment of code-correlation OTDR in which a second code-correlation stage is added.

FIG. 3: Arrangement for simple practical implementation of a basic embodiment of the invention

FIG. 4: Measured sensitivity and resolution using the proof-of-concept arrangement.

### DETAILED DESCRIPTION OF THE PREFERRED EMBODIMENT

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

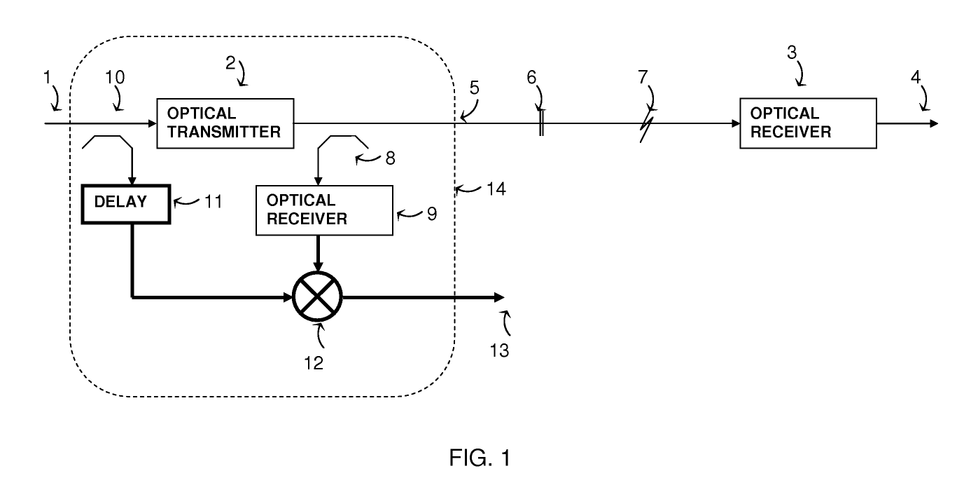

A basic operational schematic of the proposed optical reflectometer is shown in FIG. 1. This particular embodiment applies to fiber-optic communications. An input signal 1 to be transmitted is fed to an optical transmitter 2 converting the electrical signal to an optical signal. The output optical signal is then transmitted through a length of optical fiber and detected by an optical receiver 3, converting the optical signal back to an electrical signal 4. In the fiber, there are several points where reflections occur, it can be in the interface between the transmitter and the external optical fiber 5, optical connectors or other components that has been purposely placed in the transmission path 6, or it can be optical reflections occurring in the fiber from breaks 7 or from Rayleigh scattering. Reflections in the optical fiber can be detected by tapping off part of the reflected light 8, detecting the light using an optical receiver 9 and comparing it to the original signal that has been tapped off 10 and delayed 11. A range of components can be used to perform the comparison, for example a multiplier device 12, such as a mixer. The result from the comparison forms the output signal 13. The extent of the invention is indicated by the dashed border 14 which incorporates the extent of a transmitter with built-in test reflectometry test capability. The use of the transmitted data to form the code sequence for built-in test reflectometry allows the transmitter to monitor fiber health during normal operation in which information bearing signals are transmitted to a receiver. This distinguishes this current invention from previous art.

In a first preferred embodiment, the input signal 1 consists of binary data. A sequence of the transmitted data is captured, delayed 11. In this embodiment, the captured signal is used to invert the received signal in the mixer 12. If the delay 11 is equal to the round-trip delay in the optical fiber to a strong reflection point 6 a strong autocorrelation signal 13 is obtained. The correlated signal may be obtained by repeating the measurement described above. Provided a quasi-random nature of captured sequences, once a comparison has been performed, the procedure can be repeated using the same delay. The strength of the correlated signal will accumulate fast while noise or random artifacts from the imperfect autocorrelation nature of a typical captured code sequence will be relatively suppressed due to its statistical nature. In this manner, the sensitivity of the measurement will be increased to detect very weak reflected signals, potentially as weak as Rayleigh scattering. Further, by changing the delay 11 any point in the optical fiber can be monitored for reflections.

Reduced measurement time may be reached if the captured code can simultaneously be delayed by several values 11. Now, the detected and reflected signal 10 is split into several paths and compared to the differently delayed reference signals in several mixers 12 each with its own delay value. In FIG. 1 only one mixing stage is shown for clarity. However, each part in FIG. 1 denoted with bold lines would be multiplied in this parallel architecture. Potentially, every reflection point in the fiber can be evaluated simultaneously in this manner.

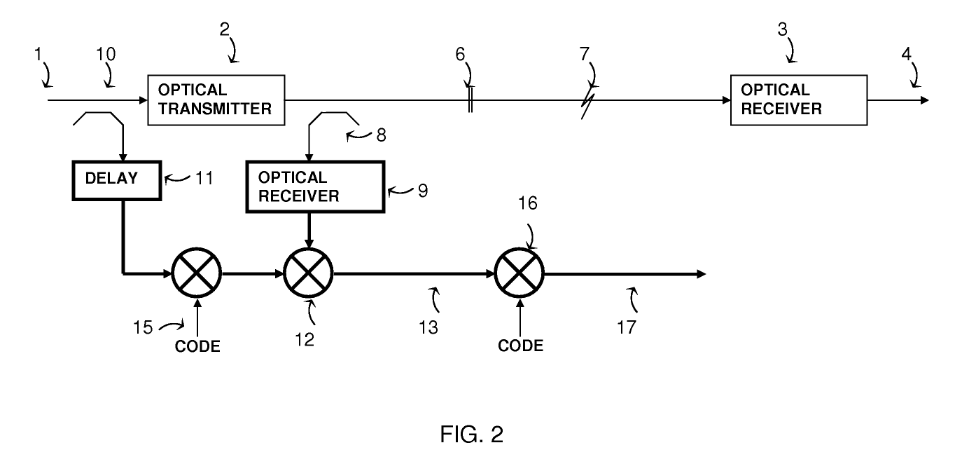

FIG. 2 shows a second preferred embodiment in which increased efficiency and reduced circuit complexity may be obtained. For large resolutions or long spans of optical fiber the number of parallel stages described above can be large. One method to reduce the number of parallel mixers is to provide a second coding stage, indicated by the inclusion of the mixers 15 and 16. A shorter first code length can now be captured, leading to fewer required delays. Each code is now repeated several times determined by the length of the code and the total length of the fiber so that reflections from the entire fiber span can be detected. To be able to distinguish between the several reflections that return the same reflection profile over the fiber due to the repeated first code, a second encoding stage is applied in mixer 15 inverting some reference code sequences. Any sequence can be chosen for second code, so these can be complementary Golay codes that exhibit a clean autocorrelation function. By then applying the same second code to the fist stage auto-correlated signal 13 in mixer 16, each reflection point in the fiber can now be evaluated simultaneously.

If the reflected signal is digitized using an analog-to-digital converter (ADC), the hardware implementation shown in FIG. 1 and FIG. 2 can be implemented using software based digital signal processing. For high-resolution applications either a very high-speed ADC has to be used that generates a very high data output volume. Alternatively a hybrid approach can be applied where only the last code-correlation stage shown in FIG. 2 is performed using software. This will allow a lower speed ADC to be used, reducing the generated data volume from the reduction of data rate following the first stage auto-correlation. Further, using software implemented digital signal processing, higher sensitivity can be obtained by artificially reducing the resolution of the measurement. In a similar manner, the amount of required processing power can be controlled by performing the highest resolution analysis of captured data only in the vicinity of selected delay values.

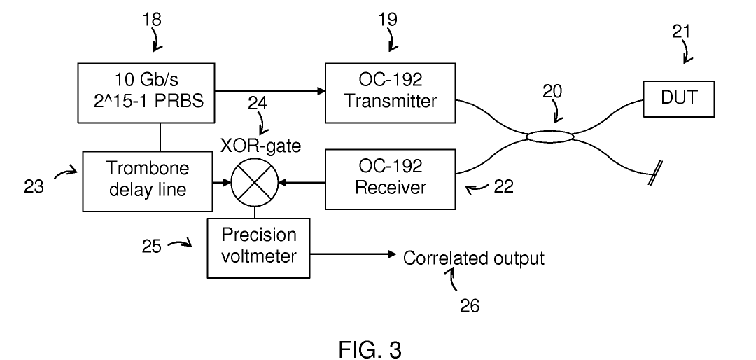

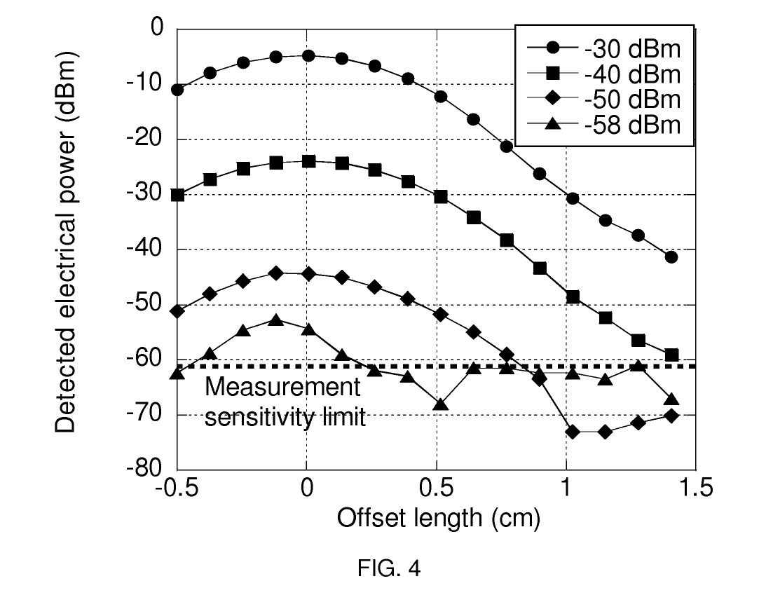

FIG. 3 shows a practical example of a simple implementation of the most basic embodiment of the invention. A 10 Gbps pseudo random bit sequencer (PRBS) 18 is used to simulate random data traffic. Part of the output is used to drive an OC-192 optical transmitter 19, designed for 10 Gbps optical transmission of binary data signals. A 2×2 50% fused optical fiber coupler 20 was connected to the transmitter. One of the coupler output is connected to the device under test 21, typically a length of fiber with one or more reflection points. The other output branch of the 2×2 coupler is terminated with suppressed reflections. The One remaining port of the 2×2 coupler is connected to an OC-192 optical receiver 22. The received reflected signal is then compared to the original PRBS signal, which has been delayed using a sliding trombone delay 23, in an XOR-gate 24, here used as a mixer. The correlated signal amplitude is then measured using a precision voltmeter 25 providing a read-out of the measured signal 26. FIG. 4 shows the detected correlated reflection power as a function of offset length from a controlled fiber reflection for different magnitudes of reflected optical power. Resolution and sensitivity can be estimated for obtained data. The full-width-half-maximum of the point reflection is seen to be about 1 cm. This corresponds well to twice the width of a single bit in optical fiber, as expected from the autocorrelation function of the compared signals. The sensitivity is observed to be on the order of −60 dBmof reflected optical power. Improved sensitivity can be obtained by increasing the measurement averaging time, here limited to the line rate; 1/50th of a second.

What is claimed is:

1. An optical transmitter of information-carrying signals wherein simultaneously as information is transmitted from the first optical transmitter to a remote receiver through a given transmission medium, a capability to measure reflections in the transmission path is obtained by the capture of a sequence of the transmitted signal that is used to correlate with a reflected signal.

2. The transmitter of claim 1 wherein the transmission medium is optical fiber.

3. The device of claim 2 wherein the capability to measure optical reflections from the optical fiber is incorporated into an optical transmitter as a built-in test function that is functional during normal optical transmitter operation.

4. The device of claim 3, wherein the optical transmitter is transmitting binary data and sequences of transmitted data is used to correlate the reflected signal

5. The device of claim 3 or 4, wherein the received reflected signal is split into parallel paths, which of each is correlated with the transmitted code with different delay such that several points of reflection are analyzed in parallel.

6. The device of claim 3 or 4, wherein the reflected signal is digitized and parallel autocorrelation is performed using software implemented digital signal processing.

7. The device of claim 3, 4 or 5, wherein the reflected signal is correlated to a first code sequence to generate a secondary coded signal and a second code is used to obtain the correlated signal.

8. The device of claim 7, wherein the secondary coded signal is digitized and parallel autocorrelation is performed using software.
